(19) United States
(12) Patent Application Publication
(10) Pub. No.: US 2007/0036712 A1
(43) Pub. Date: Feb. 15, 2007

(54) METHOD OF HYDROGEN PRODUCTION UTILIZING SAND FOR THE MAINTENANCE OF A HIGH BIOMASS BACTERIA IN A HYDROGEN BIOREACTOR

(76) Inventors: Mitchell S. Felder, Hermitage, PA (US); Harry R. Diz, Erie, PA (US); Justin Felder, Hermitage, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/463,097

(22) Filed: Aug. 8, 2006

Related U.S. Application Data
(60) Provisional application No. 60/706,682, filed on Aug. 9, 2005.

(51) Int. Cl. C01B 3/02

(52) U.S. Cl. 423/648.1

(57) ABSTRACT

This invention provides a method for producing hydrogen through the concentrated growth of hydrogen producing microorganisms. The method comprising: providing a receptacle, introducing a material that contains a hydrogen generating microorganism into the receptacle, introducing a substrate that contains a baiting material into the receptacle, and baiting the hydrogen generating microorganisms to the substrate thereby allowing for the concentrated growth of the hydrogen generating microorganisms on the substrate.

### CROSS REFERENCE TO RELATED APPLICATIONS

This invention claims priority under 119(e) from U.S. Provisional Application No. 60/706,682, which was filed on Aug. 9, 2005 and is incorporated by reference herein.

### BACKGROUND OF THE INVENTION

1. Field of the Invention

The present invention relates generally to an apparatus for concentrated growth of hydrogen generating microorganism cultures. More particularly, this invention relates to an apparatus for the concentrated growth of hydrogen generating nonparaffinophilic microorganisms.

2. Description of the Related Art

The production of hydrogen gas is an increasingly common and important procedure in the world today. Production of hydrogen in the United States alone currently amounts to about 3 billion cubic feet (ft³) per year, with output likely to increase. Uses for the produced hydrogen are varied, ranging from utilization in welding processes to the production of hydrochloric acid. An increasingly important use of hydrogen, however, is in the production of alternative fuels for machinery, such as motor vehicles. Successful use of hydrogen as an alternative fuel can provide substantial benefits to the world at large. This is possible not only because hydrogen is produced without dependence on the location of specific oils or other ground resources, but because burning hydrogen is atmospherically clean due to the fact that essentially no carbon dioxide or greenhouse gasses are produced when hydrogen is burned. Thus, production of hydrogen as a fuel source can have great impact on the world at large.

Traditional apparatuses of hydrogen production, however, utilize significant amounts of fossil fuels in order to produce hydrogen. For instance, an electrolyzer, which generally uses electricity to decompose water into hydrogen and oxygen, requires a significant amount of fossil fuel to generate the electricity needed to power the decomposition process. Similarly, a steam reformer, which is another apparatus used to produce hydrogen, also requires a large amount of fossil fuel during the hydrogen producing process. As could be readily understood, the environmental benefits of producing hydrogen using these apparatuses and processes are partially offset because these apparatuses and processes utilize significant amounts of pollution-causing fuels, such as fossil fuels, as an energy source during hydrogen production. Accordingly, there is a need for a method of producing hydrogen that significantly reduces the consumption of fossil fuel during the hydrogen production process.

### SUMMARY OF THE INVENTION

This need and others are met by various embodiments of this invention which provide a method for producing hydrogen through the concentrated growth of hydrogen producing microorganisms.

In accordance with one embodiment of the invention, a method of producing hydrogen comprising: providing a receptacle, introducing a material that contains a hydrogen generating microorganism into the receptacle, introducing a substrate that contains a baiting material into the receptacle, and baiting the hydrogen generating microorganisms to the substrate thereby allowing for the concentrated growth of the hydrogen generating microorganisms on the substrate.

In accordance with another embodiment of the invention, a method for producing hydrogen comprising: providing a receptacle, introducing a material into the receptacle wherein the material is sand, introducing a hydrogen generating microorganism into the material, introducing a substrate that contains a bating material into the receptacle, and baiting the hydrogen generating microorganisms to the substrate thereby allowing for the concentrated growth of the hydrogen generating microorganisms on the substrate.

In accordance with another embodiment of the invention, a method for producing hydrogen comprising: providing a receptacle, introducing a material into the receptacle wherein the material is sand that contains a hydrogen generating nonparaffinophilic microorganism, introducing a substantially hollow substrate that contains a baiting material into the receptacle, and baiting the hydrogen generating nonparaffinophilic microorganisms to the substrate thereby allowing for the concentrated growth of the hydrogen generating microorganisms on the substrate.

One aspect to this invention is to reduce the amount of fossil fuel needed to produce hydrogen.

Another aspect to this invention is to provide an apparatus and an associated method for the concentrated growth of hydrogen producing microorganisms.

Yet another aspect to this invention is to provide a hydrogen producing apparatus, as well as an associated method, which yields a large of amount of hydrogen while minimizing the monetary costs associated with operating and maintaining such an apparatus.

### BRIEF DESCRIPTION OF THE DRAWINGS

A full understanding of the disclosed and claimed concept can be gained from the following Description when read in conjunction with the accompanying drawings in which:

FIG. 1 is a schematic of the hydrogen producing apparatus in accordance with one embodiment of the invention;

FIG. 2 is depicts one embodiment of the substrate that can be used in the apparatus of FIG. 1;

FIG. 3 is depicts the substrate of FIG. 2 in the receptacle; and

FIG. 4 is a flow chart depicting one embodiment of the method that is disclosed in this invention.

### DESCRIPTION OF THE PREFERRED EMBODIMENTS

As used herein, the term “hydrogen producing microorganisms” shall refer broadly to microorganisms that produce hydrogen gas as a result of their metabolic processes.

When referring to any numerical range of values, such ranges are understood to include each and every number and/or fraction between the stated range minimum and maximum.

Directional phrases used herein, such as, for example, upper, lower, left, right, vertical, horizontal, top, bottom, above, beneath, clockwise, counterclockwise and derivatives thereof, relate to the orientation of the elements shown in the drawings and are not limiting upon the claims unless expressly recited therein.

As stated above, traditional apparatuses and processes used to produce hydrogen consume a large amount of fossil fuel. The apparatus and method that is disclosed in this invention, however, significantly reduces the amount of fossil fuel that is consumed during the hydrogen producing process by facilitating the growth of hydrogen producing (generating) microorganisms such as, but not limited to, nonparaffinophilic bacteria that belong to the genus bacillus, clostridium, and klebsiella as well as other nonparaffinophilic microorganisms.

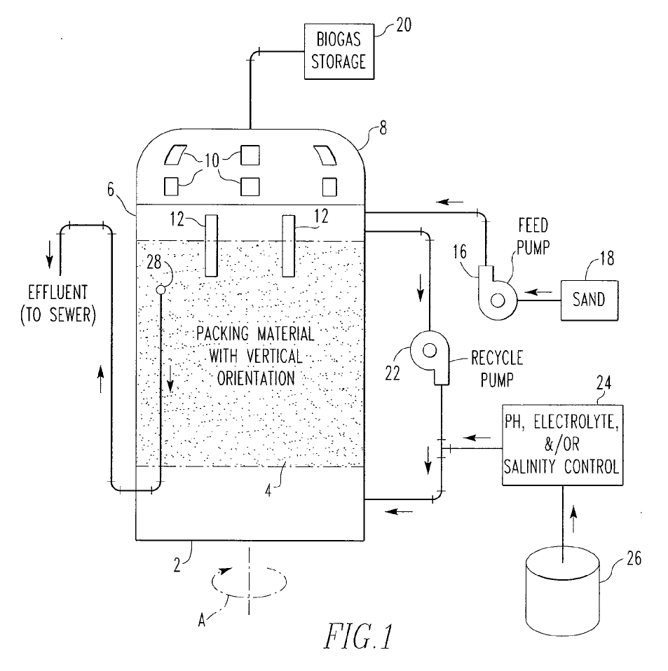

Referring to FIG. 1, a receptacle 2 (hereinafter, also referred to as the bioreactor) that is suitable for containing a material 4 within an interior cavity 6 of the receptacle 2 is provided. The size and shape of the receptacle 2 is not meant to be limiting. It should be noted, however, that as the size (e.g., diameter, height) of the receptacle 2 is increased the concentration of hydrogen producing microorganisms that are grown within the receptacle 2 can also be increased thereby generating a larger amount of hydrogen gas in the receptacle 2 which can be collected.

In one embodiment of the invention, the interior cavity 6 of the receptacle 2 can be accessed through a removable lid 8. In yet another embodiment of the invention, the interior cavity 6 of the receptacle 2 is accessed through one or more access ports 10 that are disposed on the lid 8 and/or the receptacle 2 thereby allowing for the insertion and removal of one or more substrates 12 from the receptacle 2 without having to remove the lid 8 from the receptacle 2. The receptacle 2 can also have means for periodically mixing the contents of the receptacle 2. For instance, the receptacle 2 can be mounted on an apparatus that allows the receptacle 2 to rotate about 180° or 360° in the direction of arrow A. Alternatively, the receptacle 2 can be equipped with a stirrer that is positioned within the interior cavity 6 of the receptacle 2. The stirrer can be moved using mechanical or magnetic means thereby stirring the contents of the receptacle 2. Additionally, the interior cavity 6 of the receptacle 2 may also be lined with a coating of alginate which provides a substrate on which concentrated growth of the hydrogen producing microorganisms can occur.

As will be discussed in greater detail below, the receptacle 2 may be equipped with one or more heating elements that are used to heat the material 4 that is contained within the receptacle 2. In order to regulate the temperature of the material 4, the receptacle 2 may also be equipped with means, such as a thermostat, to control the temperature of the material 4 to facilitate the growth of the hydrogen producing microorganisms in the receptacle 2 and/or to prevent the proliferation of other microorganisms that produce unwanted metabolic by-products such as methane gas. For example, hydrogen producing bacteria can typically withstand temperatures up to about 100° C. for a period ranging from about 3 hours to about 5 hours. In contrast, methane producing bacteria, such as methanogens, cannot withstand temperatures near 100° C. for more than a few minutes. Accordingly, in one embodiment of the invention, the material 4 is heated to a temperature ranging from about 90° C. to about 100° C. for a period of time ranging from about 20 minutes to about 300 minutes or, more preferably, a period of time ranging from about 20 minutes to about 30 minutes. By eliminating the bacteria that produced unwanted by-products from the material 4, the hydrogen that is ultimately produced by the hydrogen producing bacteria will not require additional purification steps in order to separate the hydrogen gas from other gases that would have been produced by the other bacteria. Because additional purification steps are not required, the cost associated with producing hydrogen using the apparatus that is disclosed in this invention is significantly less than other apparatuses that are traditionally used to produce hydrogen.

The material 4 that is introduced into the interior cavity 6 of the receptacle 2 is a material 4 that contains hydrogen producing microorganisms. The material 4, for example, can be sand or a mixture of sand and water since sand has been shown to harbor significant amounts of bacteria. For example, typical beach sand has been shown to have 5 to 10 times the amount of bacteria than water. Moreover, unlike an open water environment, bacteria can survive in sand for months at a time. Because sand naturally contains high concentrations of bacteria, the likelihood of sand containing some amount of hydrogen producing bacteria that can be grown and cultivated within the receptacle 2 is quite high. However, in order to ensure that sufficient concentrations of hydrogen producing microorganisms will be produced in the receptacle 2, the material 4 can be inoculated with additional hydrogen producing microorganisms prior to or after the introduction of the material 4 into the receptacle 2.

Continuing with FIG. 1, one or more passageways 14 such as, without limitation, pipes or tubes are used to connect the receptacle 2 to other components of the apparatus. For example, the material 4 is introduced into the interior cavity 6 of the receptacle 2 by a feed pump 16 that is connected to both the receptacle 2 as well as to the source of the material 18. A storage tank 20, which collects the gas that is produced by the hydrogen producing microorganisms, is connected to the receptacle 2 as well. A recycle pump 22, which is attached to the receptacle 2, is used to recycle additional organic material that is introduced into the receptacle 2. The additional organic material, which is used as a source of nutrients by the hydrogen producing microorganisms, is made from a material that can be metabolized by the hydrogen producing microorganisms. Continuing with FIG. 1, means 24, such as a pump, for controlling the pH, electrolyte levels, and the salinity of the material 4 is connected to the recycle pump 22. A source 26 of another material, such as a Bicarbonate solution, may also be connected to the means 24. As is known in the art, a Bicarbonate solution is used to adjust the pH of a material. However, any solution that is utilized for pH adjustment may be used in lieu of the Bicarbonate solution. Referring to FIG. 1, the receptacle 2 can also include an effluent outlet 28 for the removal of excess liquid and waste from the receptacle 2 to a remote location.

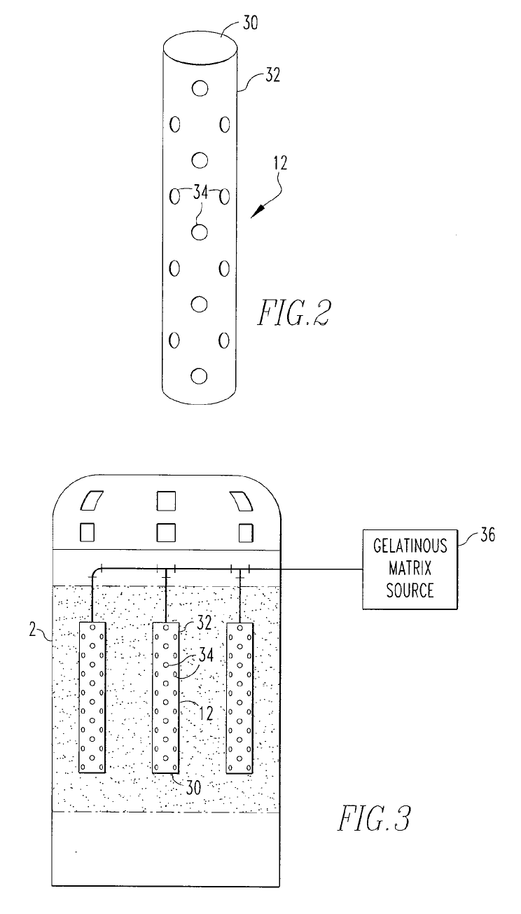

Referring to FIGS. 2 and 3, concentrated growth of the hydrogen producing microorganisms is achieved not only by adjusting the material's environmental conditions (e.g. temperature, pH, salinity, number of electrolytes) to optimize the hydrogen producing microorganisms' growth, but it is also achieved by introducing one or more substrates 12 into the interior cavity of the receptacle 2. In one embodiment of the invention, the substrate 12 has a hollow or partially hollow interior 30 (hereinafter, referred to as the interior of the substrate) that is connected to the exterior surface 32 of the substrate 12 by a plurality of channels 34 that extend from the interior 30 of the substrate to the exterior surface 32. However, a substrate 12 having a solid interior or a substrate having a solid interior with holes or passages disposed on the exterior surface 32 of the substrate 12 can also be used in this invention. The substrate 12 is typically made from a material, such as plastic, which can withstand heat up to about 110° C. so that the substrate 12 can withstand any processes that are designed to eliminate bacteria that produce unwanted by-products (see preceding paragraphs). The substrate 12 can be virtually of any shape including, but not limited to, pipe, rod, bead, slat, tube, screen, honeycomb, sphere, or a shape with latticework. As stated above, the substrates 12 are typically inserted through access ports 10 that are disposed on the receptacle 2 and/or lid 8. It should be noted, however, that the substrate 12 can also be affixed to the interior cavity 6 of the receptacle 2 either in direct contact with or substantially adjacent to the material 4 that is contained within the receptacle 2.

The substrate 12 is coated with a carbon-based baiting material that is used to cultivate the hydrogen producing microorganisms on the substrate 12 by allowing the microorganisms to obtain nutrients directly from the substrate 12 and to form a biofilm on the substrate 12. Preferably, the carbon-based baiting material is a gelatinous matrix having at least one carbon compound. The carbon compound can be selected from the group comprising, but not limited to, glucose, fructose, glycerol, mannitol, asparagines, casein, adonitol, 1-arabinose, cellobiose, dextrose, dulcitol, d-galactose, inositol, inulin, lactose, levulose, maltose, d-mannitol, d-mannose, melibiose, raffinose, rhamnose, sucrose, salicin, d-sorbintol, trihalose and d-xylose or any combination thereof. In general, the gelatinous matrix can be prepared by placing about 2 grams (g) of agar and 3 grams (g) of a carbon compound into 100 milliliters (mL) of distilled water. The ratio of agar, carbon compound, and water can be used to scale the amount of the baiting material to the desired levels. It should be noted, however, that the agar, which is a gelatinous mix, can be replaced with other gelatinous mixes that are commonly known in the art.

Once the agar, carbon compound, and distilled water have been mixed, the mixture is boiled for about 20 minutes to about 30 minutes and steamed sterilized for about 20 minutes to about 30 minutes to form a molten gelatinous matrix. While the gelatinous matrix is in molten form, the gelatinous matrix is coated onto the substrate 12. The molten gelatinous matrix can either be applied directly to the surface of the substrate 12 or it can be applied to an adhesive layer that is disposed between the coating and the substrate 12 using methods that are well known in the art. If an adhesive is used, the adhesive is of a type that is commonly known in the art for containing carbon based compounds. For example, the adhesive can be in a form a gel bead that is made from organic glue having affixed thereto, either ionically or by affinity, a carbon compound.

When the level of gelatinous matrix on the substrate 12 becomes too low, additional gelatinous matrix can be coated onto the substrate 12 to ensure that the there is sufficient carbon-based baiting material on the substrate 12 to sustain the growth of the hydrogen producing microorganisms on the substrate 12. This can be achieved by either removing the substrate 12 from the receptacle 2 and coating the substrate 12 with additional gelatinous matrix while it is outside of the receptacle 2 or, as can be seen from FIG. 3, the substrate 12 can be connected to a source 36 of the gelatinous matrix thereby allowing for the replenishment of the gelatinous matrix on the substrate 12 without having to remove the substrate 12 from the receptacle 2. For example, a pump, which is attached to the substrate 12 as well as to the source 36 of the gelatinous matrix, can be used to introduce additional gelatinous matrix onto the substrate 12.

If the concentration of hydrogen producing microorganisms needs to be increased in order to increase hydrogen output, then additional substrates 12 may be introduced into the receptacle 2. The additional substrates 12 can either have a surface area that is equal to the surface area of the substrates 12 that are currently in the receptacle 2 or the additional substrates 12 can have a surface area that is greater than the surface area of the substrates 12 that are in the receptacle 2. If a substrate 12 having a greater surface area is introduced into the receptacle 2, one would appreciate that a higher concentration of hydrogen producing microorganisms can be cultivated on that particular substrate 12 when compared to a substrate 12 with a smaller surface area.

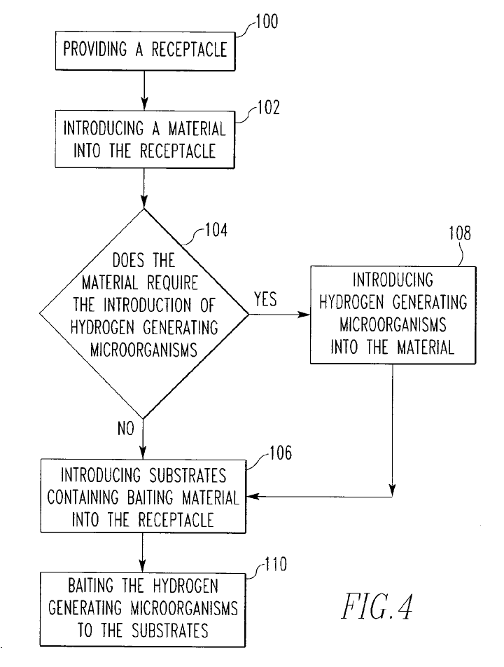

FIG. 4 is a flowchart depicting one embodiment of the invention. The method begins at step 100 where a receptacle 2 is provided. As stated above, the receptacle 2 can have a removable lid 8 or it can have one or more access ports ] 0 through which the material 4 and the substrates 12 will be introduced into the receptacle 2. After the receptacle 2 has been provided, as at step 100, the material 4, which can either be sand or a mixture of sand and water, is then introduced into the receptacle 2. After the material 4 has been introduced into the receptacle 2, it is determined, at step 104, whether the material 4 requires the introduction of hydrogen generating microorganisms. If, at step 104, it is determined that the material 4 does not require additional hydrogen generating microorganisms (e.g. the population of the hydrogen generating microorganisms in the material 4 is sufficient), then the substrates 12 that contain the baiting material, which is described above, is introduced into the receptacle 2, at step 106. If, on the other hand, it is determined, at step 104, that hydrogen generating microorganisms need to be introduced into the material 4, then the hydrogen generating microorganisms are introduced, as at step 108, into the material 4 prior to the introduction of the substrates 12 into the receptacle at step 106. The need for introducing the hydrogen generating microorganisms into the material 4, at step 108, can occur in a number of instances. For example, if the material 4 that is introduced into the receptacle 2 does not contain hydrogen generating microorganisms or if the population of the hydrogen generating microorganisms in the material 4 is relatively small, then hydrogen generating microorganisms are introduced into the material 4 at step 108. Continuing with FIG. 4, after the substrates 12 containing the baiting material have been introduced, at step 106, into the receptacle 2, the hydrogen generating microorganisms are then baited, as at step 110, to the substrates 12 thereby allowing for the concentrated growth of the hydrogen generating microorganisms on the substrates 12. The hydrogen that is produced by the hydrogen generating microorganism can then be collected in the hydrogen gas storage tank 20, which is described above, or the hydrogen generating microorganisms themselves can be relocated to another storage receptacle.

In another embodiment of the invention, the substrates 12 are introduced into the receptacle 2 prior to the introduction of the hydrogen generating microorganisms into the material 4.

While specific embodiments of the invention have been described in detail above, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed and claimed concept which is to be given the full breadth of the claims appended and any and all equivalents thereof.

What is claimed is:

1. A method for producing hydrogen comprising:
providing a receptacle;
introducing a material into said receptacle, said material containing a hydrogen generating microorganism;
introducing a substrate into said receptacle, said substrate containing a baiting material; and
baiting said hydrogen generating microorganisms to said substrate thereby allowing for the concentrated growth of said hydrogen generating microorganisms on said substrate.

2. The method according to claim 1, further comprising providing a storage tank that is connected to said receptacle and collecting the hydrogen gas that is produced by said hydrogen generating microorganisms in said storage tank.

3. The method according to claim 1, wherein said material is sand.

4. The method according to claim 1, further comprising introducing as said material a mixture of sand and water.

5. The method according to claim 1, further comprising introducing as said material a material that contains as said hydrogen generating microorganism a nonparaffinophilic bacteria.

6. The method according to claim 1, further comprising introducing additional amounts of said hydrogen generating microorganisms to said material.

7. The method according to claim 1, further comprising adjusting the pH, temperature, salinity, and oxygen levels of said material to cultivate growth of said hydrogen generating microorganisms on said substrates.

8. The method according to claim 7, further comprising adjusting the temperature of said material to prevent the growth of a microorganism that produces methane.

9. The method according to claim 1, further comprising providing a source of said material, said source being connected to said receptacle, and introducing additional amounts of said material into said receptacle from said source.

10. The method according to claim 1, wherein said baiting material is a mixture of water, agar, and a carbon compound.

11. The method according to claim 10, wherein said carbon compound is selected from glucose, fructose, glycerol, mannitol, asparagines, casein, adonitol, 1-arabinose, cellobiose, dextrose, dulcitol, d-galactose, inositol, inulin, lactose, levulose, maltose, d-mannitol, d-mannose, melibiose, raffinose, rhamnose, sucrose, salicin, d-sorbintol, trihalose and d-xylose or any combination thereof.

12. A method for producing hydrogen comprising:
providing a receptacle;
introducing a material into said receptacle, said material being sand;
introducing a hydrogen generating microorganism into said material;
introducing a substrate into said receptacle, said substrate containing a baiting material; and
baiting said hydrogen generating microorganisms to said substrate thereby allowing for the concentrated growth of said hydrogen generating microorganisms on said substrate.

13. The method according to claim 12, wherein said baiting material is a mixture of water, agar, and a carbon compound.

14. The method according to claim 13, wherein said carbon compound is selected from glucose, fructose, glycerol, mannitol, asparagines, casein, adonitol, 1-arabinose, cellobiose, dextrose, dulcitol, d-galactose, inositol, inulin, lactose, levulose, maltose, d-mannitol, d-mannose, melibiose, raffinose, rhamnose, sucrose, salicin, d-sorbintol, trihalose and d-xylose or any combination thereof.

16. A method for producing hydrogen comprising:
providing a receptacle;
introducing a material into said receptacle, said material being sand that contains a hydrogen generating nonparaffinophilic microorganism;
introducing a substrate into said receptacle, said substrate being substantially hollow and containing a baiting material; and
baiting said hydrogen generating nonparaffinophilic microorganisms to said substrate thereby allowing for the concentrated growth of said hydrogen generating microorganisms on said substrate.

17. The method according to claim 16, wherein said baiting material is a mixture of water, agar, and a carbon compound.

18. The method according to claim 17, wherein said carbon compound is selected from glucose, fructose, glycerol, mannitol, asparagines, casein, adonitol, 1-arabinose, cellobiose, dextrose, dulcitol, d-galactose, inositol, inulin, lactose, levulose, maltose, d-mannitol, d-mannose, melibiose, raffinose, rhamnose, sucrose, salicin, d-sorbintol, trihalose and d-xylose or any combination thereof.

19. The method according to claim 16, further comprising stirring said material periodically.

20. The method according to claim 16, further comprising adjusting the pH, temperature, salinity, and oxygen levels of said material to cultivate growth of said hydrogen generating microorganisms on said substrates.
